(19) United States
(12) Patent Application Publication
(10) Pub. No.: US 2023/0352964 A1
(43) Pub. Date: Nov. 2, 2023

(54) Vehicle Battery Charging Apparatus and Method for Controlling the Same

(71) Applicants: Hyundai Motor Company, Seoul (KR); Kia Corporation, Seoul (KR)

(72) Inventors: Bo Geum Jung, Daegu (KR); Myoung Seok Lee, Seoul (KR)

(21) Appl. No.: 17/943,353

(22) Filed: Sep. 13, 2022

(30) Foreign Application Priority Data
Apr. 27, 2022 (KR) 10-2022-0052246

(51) Int. Cl. H02J 7/14; B60L 53/30

(52) U.S. Cl. CPC H02J 7/1469; B60L 53/305

(57) ABSTRACT

An embodiment vehicle battery charging apparatus includes a power supply chip enabled according to voltage levels of a control pilot signal and a chip enable signal to supply an internal power supply voltage, a charging controller configured to receive the internal power supply voltage and control charging of a vehicle battery based on the control pilot signal, and a chip enable circuit configured to receive the internal power supply voltage, receive the control pilot signal, and adjust a voltage level of the chip enable signal based on a voltage level of the control pilot signal to enable the power supply chip.

### CROSS-REFERENCE TO RELATED APPLICATIONS

This application claims the benefit of Korean Patent Application No. 10-2022-0052246, filed on Apr. 27, 2022, which application is hereby incorporated herein by reference.

### TECHNICAL FIELD

The present disclosure relates to a vehicle battery charging apparatus and a method for controlling the same.

### BACKGROUND

Vehicles such as plug-in hybrid electric vehicles (PHEVs) and electric vehicles (EVs) are each charged with electricity from an external power source such as EVSE and driven by using the charged electricity as a power source.

The EVSE and a vehicle are connected through a power line, a control pilot line, and a proximity detection line.

The power line is connected between a power supply of the EVSE and a vehicle battery charging apparatus such as an on-board charger (OBC) inside the vehicle.

The control pilot line is a line for exchanging information between the EVSE and the vehicle, and a control board of the EVSE communicates with the vehicle battery charging apparatus through this line.

The proximity detection line functions to detect whether the vehicle is correctly engaged with the power supply inside the EVSE.

In order to charge the vehicle battery, the vehicle battery charging apparatus inside the vehicle needs to be operated. However, the user usually parks the vehicle and turns off the ignition when charging the vehicle battery.

Therefore, when the user engages a charging connector after turning off the vehicle ignition, the vehicle supplies power to the vehicle battery charging apparatus based on a control pilot signal input from the EVSE so that the vehicle battery charging apparatus operates.

The matters described as the related art above are only for improving the understanding of the background of embodiments of the present disclosure, and should not be taken as acknowledging that the matters correspond to the prior art known to those of ordinary skill in the art.

### SUMMARY

The present disclosure relates to a vehicle battery charging apparatus and a method for controlling the same. Particular embodiments relate to an apparatus and a method capable of more safely and effectively charging a vehicle battery using electric vehicle supply equipment (EVSE).

Therefore, embodiments of the present disclosure have been made in view of problems in the art, and it is an embodiment of the present disclosure to stably supply power of a vehicle battery charging apparatus based on a control pilot signal regardless of a sequence of control pilot communication, which is different according to a type of EVSE.

It is another embodiment of the present disclosure to use internal power supplied from a power supply chip inside a vehicle battery charging apparatus instead of power of an auxiliary battery to maintain an enabled state of the power supply chip, thereby reducing the cost and area consumed by the vehicle battery charging apparatus and alleviating discharge of the auxiliary battery.

It is a further embodiment of the present disclosure to stably supply power of a vehicle battery charging apparatus based on a control pilot signal without affecting a frequency and a duty ratio of the control pilot signal.

The technical features achievable in embodiments of the present disclosure are not limited to the technical features mentioned above, and other technical features not mentioned will be clearly understood by those of ordinary skill in the art to which the present disclosure belongs from the description below.

In accordance with an embodiment of the present disclosure, the above and other features can be accomplished by the provision of a vehicle battery charging apparatus including a power supply chip enabled according to voltage levels of a control pilot signal and a chip enable signal to supply an internal power supply voltage, a charging controller configured to receive the internal power supply voltage and control charging of a vehicle battery based on the control pilot signal, and a chip enable circuit configured to receive the internal power supply voltage, receive the control pilot signal, and adjust a voltage level of the chip enable signal based on a voltage level of the control pilot signal to enable the power supply chip.

The control pilot signal may be changed to any one of a plurality of preset states according to a battery charging sequence between EVSE and a vehicle.

The power supply chip may be enabled when a voltage level of the control pilot signal is a preset voltage level or higher, and the preset voltage level may be set between a maximum voltage level and a minimum voltage level of the control pilot signal corresponding to a state in which the vehicle is connected to the EVSE and is not ready to receive power among the plurality of preset states.

The chip enable circuit may adjust a voltage level of the chip enable signal to the preset voltage level or higher.

The power supply chip may be enabled when the voltage level of the chip enable signal is the preset voltage level or higher.

The chip enable circuit may include an RC circuit including a resistor having a resistance and a capacitor having a capacitance, and the RC circuit may adjust the voltage level of the chip enable signal to a preset voltage level or higher by charging/discharging the capacitor according to a time constant determined by the resistance and the capacitance at a voltage level of the control pilot signal corresponding to a state in which the vehicle is connected to the EVSE and is not ready to receive power among the plurality of preset states.

The chip enable circuit may further include an operational amplifier configured to receive the control pilot signal through a non-inverting input terminal based on the internal power supply voltage, buffer the control pilot signal, and output the control pilot signal to the RC circuit, and a positive diode connected between an output terminal and an inverting input terminal of the operational amplifier.

The charging controller may control charging of the vehicle battery by detecting a voltage level, a frequency, and a duty ratio of the control pilot signal.

In accordance with another embodiment of the present disclosure, there is provided a method for controlling a vehicle battery charging apparatus, the method including receiving input of a control pilot signal, outputting, by a power supply chip, an internal power supply voltage according to a voltage level of the control pilot signal, receiving, by a chip enable circuit, the internal power supply voltage to receive the control pilot signal, and enabling, by the chip enable circuit, the power supply chip by adjusting a voltage level of a chip enable signal based on the voltage level of the control pilot signal.

The receiving input of the control pilot signal may include receiving input of the control pilot signal having a voltage level corresponding to a state in which a vehicle is connected to EVSE and is not ready to receive power.

The outputting may include outputting the internal power supply voltage in a section in which the voltage level of the control pilot signal is a preset voltage level or higher in the power supply chip.

The enabling may include enabling the power supply chip by adjusting the voltage level of the chip enable signal to a preset voltage level or higher.

### BRIEF DESCRIPTION OF THE DRAWINGS

The above and other objects, features and other advantages of embodiments of the present disclosure will be more clearly understood from the following detailed description taken in conjunction with the accompanying drawings, in which:

FIG. 1 is a diagram illustrating a configuration of a vehicle battery charging system according to an embodiment of the present disclosure;

FIG. 2 is a diagram for describing a state of a control pilot signal according to a vehicle battery charging sequence between a vehicle and EVSE illustrated in FIG. 1;

FIG. 3 is a block diagram illustrating a configuration according to an embodiment of a vehicle battery charging apparatus included in the vehicle illustrated in FIG. 1;

FIG. 4 is a circuit diagram according to an embodiment of a chip enable circuit illustrated in FIG. 3;

FIG. 5 is a waveform diagram for describing an operation of the chip enable circuit illustrated in FIG. 4; and

FIG. 6 is a flowchart for describing a control method of the vehicle battery charging apparatus illustrated in FIG. 3.

### DETAILED DESCRIPTION OF ILLUSTRATIVE EMBODIMENTS

In the description of the following embodiments, the term “preset” means that, when a parameter is used in a process or algorithm, a value of the parameter is predetermined. The value of the parameter may be set when the process or algorithm is started, or may be set during a period in which the process or algorithm is performed, according to an embodiment.

Terms such as “first” and “second” used to distinguish various elements are not limited by the elements. For example, a first element may be referred to as a second element, and conversely, a second element may be referred to as a first element.

It should be understood that when one element is “coupled” or “connected” to another element, the elements may be directly coupled or connected via another element therebetween. On the other hand, descriptions of “directly coupled” and “directly connected” should be understood to indicate that one element is directly connected to another element without interposing another element therebetween.

Hereinafter, the present disclosure will be described in more detail through embodiments. These embodiments are only for illustrating the present disclosure, and the scope of protection of the rights of the present disclosure is not limited by these embodiments.

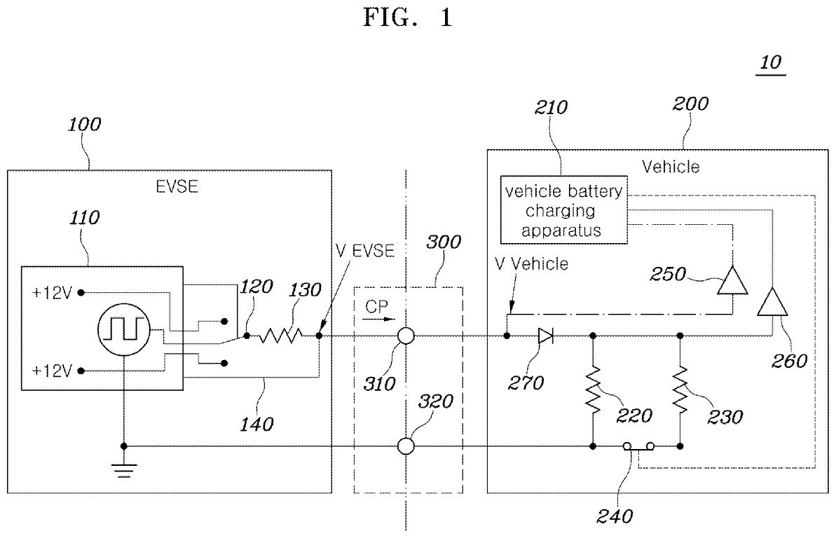

FIG. 1 is a diagram illustrating a configuration of a vehicle battery charging system 10 according to an example of the present disclosure. As illustrated in FIG. 1, the vehicle battery charging system 10 may include EVSE 100, a vehicle 200, and a charging connector 300.

The vehicle battery charging system 10 may allow communication between the EVSE 100 and the vehicle 200 through a control pilot signal CP. The control pilot signal CP may be transmitted or received through a transmission line between a node having an EVSE output terminal voltage V EVSE and a node having a vehicle input terminal voltage V Vehicle.

To charge a vehicle battery inside the vehicle 200, the EVSE 100 may change a voltage level, a frequency, and a duty ratio of the control pilot signal CP according to a preset control pilot communication sequence and transmit the control pilot signal CP to the vehicle 200. The duty ratio of the control pilot signal CP may be varied according to current limiting capacity information of the EVSE 100.

The EVSE 100 may include a switch 120 selectively connecting +12V, −12V, and pulse width modulation (PWM) signals, and a resistor 130 connected in series with the switch 120. Upon confirming a normal connection state between the EVSE 100 and the vehicle 200 by the charging connector 300 through a signal sensed through a measurement line 140, a control board 110 may output the PWM signal as the control pilot signal CP. The control pilot signal CP may be changed to any one of a plurality of preset states according to a battery charging sequence between the EVSE and the vehicle.

The vehicle 200 includes a vehicle battery charging apparatus 210 for charging a vehicle battery (not illustrated).

The vehicle battery charging apparatus 210 may be enabled by receiving power based on the control pilot signal CP. More specifically, the vehicle battery charging apparatus 210 may be stably enabled when a voltage level of the control pilot signal CP continues for a certain period above a preset voltage level. Here, the preset voltage level may be set between a maximum voltage level and a minimum voltage level of the control pilot signal CP corresponding to a state, in which the vehicle 200 is connected to the EVSE 100 and is not ready to receive power, among a plurality of preset states for the control pilot signal CP.

The vehicle battery charging apparatus 210 may control charging of the vehicle battery by detecting the voltage level, the frequency, and the duty ratio of the control pilot signal CP.

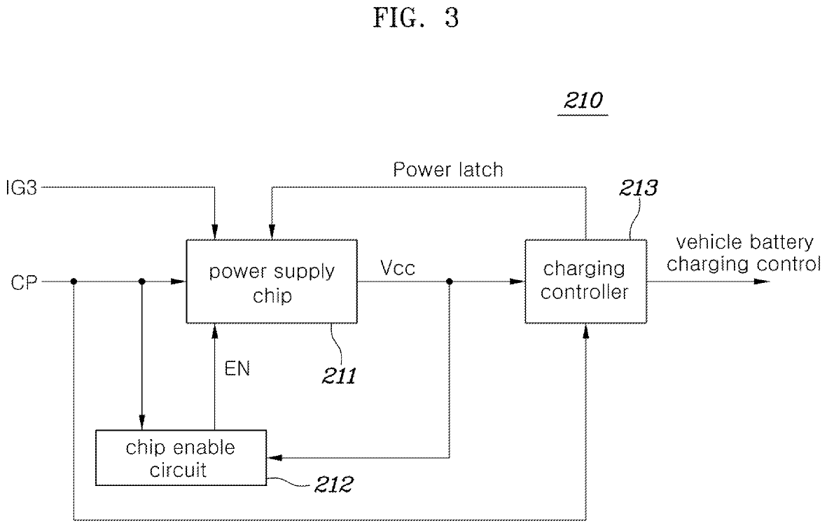

The vehicle battery charging apparatus 210 may be implemented as an on-board charger (OBC) or a vehicle charging management system (VCMS). A configuration and operation method of the vehicle battery charging apparatus 210 will be described in detail later with reference to FIG. 3.

The vehicle 200 includes a resistor 220 connected to a resistor 130, a resistor 230 connected in parallel with the resistor 220, and a switch 240 for connecting or disconnecting the resistor 230 between the resistor 220 and the resistor 230.

The vehicle 200 includes a buffer circuit 250 for measuring a voltage at one end of the resistor 220 and a buffer circuit 260 connected to one end of the resistor 230 by a branch to measure a frequency and/or a pulse width. The buffer circuits 250 and 260 perform a function of amplifying without affecting a measurement point.

The vehicle 200 includes a positive diode 270 at a front end of the resistor 220. The positive diode 270 prevents current from flowing in a reverse direction.

According to an embodiment, the vehicle 200 may be implemented as a general EV that obtains power by using only electrical energy, an HEV that acquires power by using both thermal energy and electrical energy from combustion of fossil fuels, a PHEV that uses both thermal energy and electrical energy from combustion of fossil fuels and may receive electrical energy from the outside to charge a built-in storage battery, a fuel cell electric vehicle (FCEV), etc.

The charging connector 300 may include a plurality of electric wires to connect between the EVSE 100 and the vehicle 200. Some electric wires 310 and 320 of the plurality of electric wires may be used to transmit signals, and others may be used to transmit power.

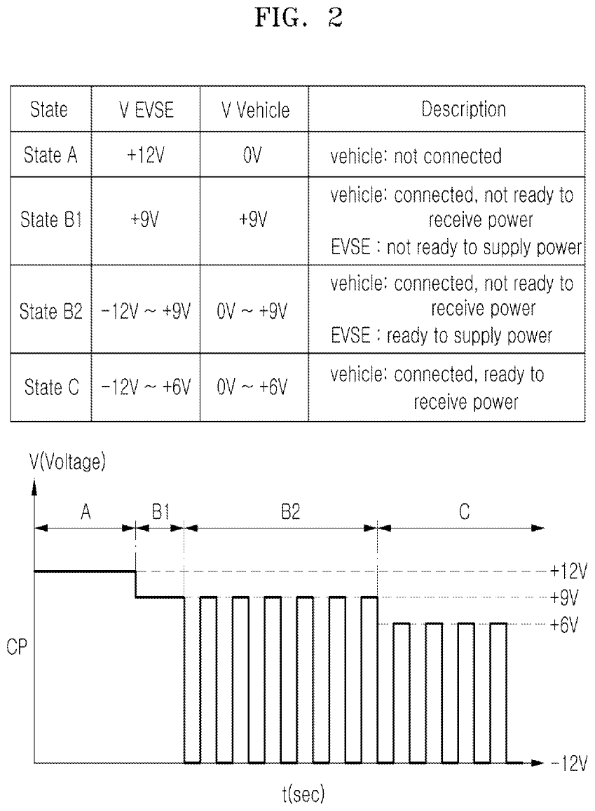

FIG. 2 is a diagram for describing a state of the control pilot signal CP according to the vehicle battery charging sequence between the EVSE 100 and the vehicle 200 illustrated in FIG. 1.

As illustrated in FIG. 2, according to the vehicle battery charging sequence between the EVSE 100 and the vehicle 200, the state of the control pilot signal CP is sequentially transitioned to a first state (State A), a second state (State B1), a third state (State B2), and a fourth state (State C). Depending on the type of EVSE, the state of the control pilot signal CP may be transitioned from the first state (State A) to the third state (State B2) without undergoing the second state (State B1).

The first state (State A) is a state when the charging connector 300 between the EVSE 100 and the vehicle 200 is not connected. Since the charging connector 300 between the EVSE 100 and the vehicle 200 is not connected in the first state (State A), in the first state (State A), a level of the EVSE output terminal voltage V EVSE is a DC voltage +12 V, and a level of the vehicle input terminal voltage V Vehicle is 0 V.

The second state (State B1) is a state when the charging connector 300 between the EVSE 100 and the vehicle 200 is connected. In the second state (State B1), since the charging connector 300 between the EVSE 100 and the vehicle 200 is connected, in the second state (State B1), each of the levels of the EVSE output terminal voltage V EVSE and the vehicle input terminal voltage V Vehicle is a DC voltage +9V. In the second state (State B1), the EVSE 100 is not ready to supply power, and the vehicle 200 is not ready to receive power.

The third state (State B2) is a state when the charging connector 300 between the EVSE 100 and the vehicle 200 is connected. In the third state (State B2), the level of the EVSE output terminal voltage V EVSE is periodically changed between −12 V and +9 V, and the level of the vehicle input terminal voltage V Vehicle is periodically changed between 0 V and +9 V. In the third state (State B2), the EVSE 100 is ready to supply power, and the vehicle 200 is not ready to receive power.

The fourth state (State C) is a state when the switch 240 is turned on and the vehicle battery charging apparatus 210 is ready to receive power. In the fourth state (State C), the level of the EVSE output terminal voltage V EVSE is periodically changed between −12 V and +6 V, and the level of the vehicle input terminal voltage V Vehicle is periodically changed between 0 V and +6 V. In the fourth state (State C), the EVSE 100 is ready to supply power, and the vehicle 200 is ready to receive power.

On the other hand, when the state of the control pilot signal CP is maintained as the second state (State B1) for a certain time or more, the control pilot signal CP is applied as a DC voltage of +9 V, and thus the vehicle battery charging apparatus 210 may be stably enabled.

However, depending on the type of EVSE, when the state of the control pilot signal CP directly transitions from the first state (State A) to the third state (State B2), due to a low duty ratio of the control pilot signal CP in the third state (State B2), the vehicle battery charging apparatus 210 may not be stably enabled.

For example, when the frequency of the control pilot signal CP is 1 kHz, the period of the control pilot signal CP is 1 ms. In this case, when the duty ratio of the control pilot signal CP is input to the vehicle battery charging apparatus 210 as 3% in the third state (State B2), the control pilot signal CP is activated for 30 μs.

Since it is difficult for the vehicle battery charging apparatus 210 to maintain an enabled state for 30 μs when the control pilot signal CP is activated, the vehicle battery charging apparatus 210 may be repeatedly in the enabled state and a disabled state. When the vehicle battery charging apparatus 210 is repeatedly in the enabled state and the disabled state, there is a problem in that the vehicle battery is not charged even when the charging connector 300 is engaged with the vehicle 200.

Accordingly, an embodiment of the present disclosure proposes that, even when the state of the control pilot signal CP directly transitions from the first state (State A) to the third state (State B2), the vehicle battery charging apparatus 210 be stably enabled, so that the vehicle battery is stably charged. A structure therefor is illustrated in FIG. 3.

FIG. 3 is a block diagram illustrating a configuration according to an embodiment of the vehicle battery charging apparatus 210 included in the vehicle 200 illustrated in FIG. 1. As illustrated in FIG. 3, the vehicle battery charging apparatus 210 may include a power supply chip 211, a chip enable circuit 212, and a charging controller 213.

The power supply chip 211 may be enabled based on charging state power IG3, the control pilot signal CP, a chip enable signal EN, and a power latch signal Power latch to supply an internal power supply voltage Vcc. A level of the internal power supply voltage Vcc may be variously set according to an embodiment.

The power supply chip 211 may be enabled according to the voltage levels of the control pilot signal CP and the chip enable signal EN to supply the internal power supply voltage Vcc. More specifically, the power supply chip 211 may be enabled when the voltage level of the control pilot signal CP and/or the chip enable signal EN is greater than or equal to a preset voltage level to supply the internal power supply voltage Vcc. The preset voltage level for enabling the power supply chip 211 may be variously set according to an embodiment.

A period in which the power supply chip 211 is enabled may vary according to the duty ratio of the control pilot signal CP. The period in which the power supply chip 211 is enabled may increase as the duty ratio of the control pilot signal CP increases. Accordingly, as the duty ratio of the control pilot signal CP increases, the power supply chip 211 may more stably supply the internal power supply voltage Vcc.

The power supply chip 211 may be enabled when the charged state power source IG3 is supplied to supply the internal power supply voltage Vcc. The charging state power IG3 is power supplied to the vehicle (200 of FIG. 1) in a charging state.

The power supply chip 211 may be enabled when the power latch signal Power latch is activated to supply the internal power supply voltage Vcc. The power latch signal Power latch may be activated in the charging controller 213 to continuously enable the power supply chip 211 even when the charging state power IG3 is not supplied or the control pilot signal CP is deactivated.

The chip enable circuit 212 may receive the internal power supply voltage Vcc from the power supply chip 211 to receive the control pilot signal CP.

The chip enable circuit 212 may adjust the voltage level of the chip enable signal EN to a preset voltage level or higher in order to stably enable the power supply chip 211 based on the voltage level of the control pilot signal CP.

The chip enable circuit 212 may include a resistor having a resistance and a capacitor having a capacitance. The chip enable circuit 212 may adjust the voltage level of the chip enable signal EN to the preset voltage level or higher by charging and discharging the capacitor according to a time constant determined by the resistance of the resistor and the capacitance of the capacitor at a voltage level of the pilot signal CP corresponding to a state (that is, the third state (State B2)), in which the vehicle 200 is connected to the EVSE 100 and is not ready to receive power, among the plurality of preset states for the control pilot signal CP. Accordingly, even when the state of the control pilot signal CP directly transitions from the first state (State A) to the third state (State B2), the chip enable circuit 212 maintains the voltage level of the chip enable signal EN at the preset voltage level or higher, thereby stably enabling the power supply chip 211.

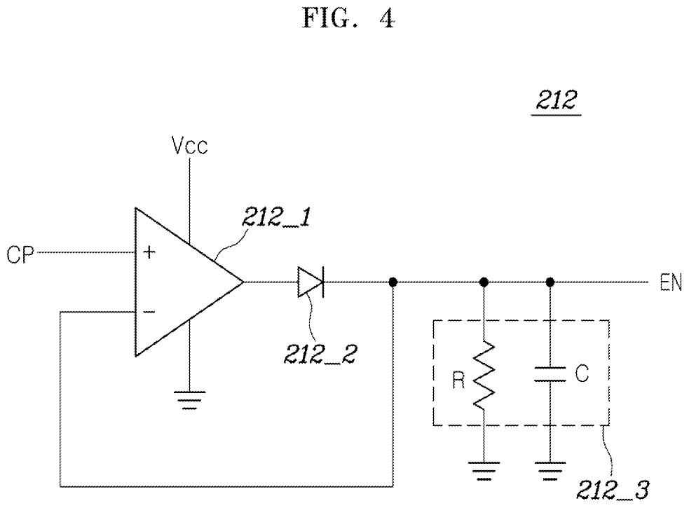

A configuration and operation method of the chip enable circuit 212 will be described in detail later with reference to FIG. 4.

The charging controller 213 may receive the internal power supply voltage Vcc from the power supply chip 211 to detect the voltage level, the frequency, and the duty ratio of the control pilot signal CP, thereby controlling charging of the vehicle battery. The charging controller 213 may be implemented as a microcontroller (MCU).

The charging controller 213 may receive the internal power supply voltage Vcc to activate the power latch signal Power latch for enabling the power supply chip 211. Accordingly, the charging controller 213 may continuously enable the power supply chip 211 based on the activated power latch signal Power latch. In addition, the charging controller 213 may end a sequence of charging the vehicle battery based on the power latch signal Power latch.

Meanwhile, the vehicle battery charging apparatus 210 includes an auxiliary microcontroller and an auxiliary power supply chip operating based on power normally supplied from an auxiliary battery inside the vehicle in order to stably enable the power supply chip 211 even when the duty ratio of the control pilot signal CP is small. Such a method requires a large consumption area and is disadvantageous in terms of cost since the auxiliary power supply chip and the auxiliary microcontroller need to be separately included.

Therefore, when the vehicle battery charging apparatus 210 includes the chip enable circuit 212 that detects the voltage level of the control pilot signal CP based on the internal power supply voltage Vcc supplied from the power supply chip 211 instead of the separate auxiliary power supply chip and auxiliary microcontroller operated based on the power normally supplied from the auxiliary battery, it is possible to reduce the cost and area consumed by the vehicle battery charging apparatus 210.

In addition, since the method of separately including the auxiliary power supply chip and the auxiliary microcontroller is a method based on power supplied from the auxiliary battery, current consumption is large in a state where the ignition of the vehicle (200 of FIG. 1) is turned off. Accordingly, discharge of the auxiliary battery may be alleviated through the chip enable circuit 212 that operates temporarily.

FIG. 4 is a circuit diagram according to an example of the chip enable circuit 212 illustrated in FIG. 3. As illustrated in FIG. 4, the chip enable circuit 212 may include an operational amplifier 212_1, a positive diode 212_2, and an RC circuit 212_3.

The operational amplifier 212_1 may receive the control pilot signal CP through a non-inverting input terminal based on the internal power supply voltage Vcc and a ground voltage, buffer the control pilot signal CP, and output the control pilot signal CP to an output terminal. An inverting input terminal of the operational amplifier 212_1 may be connected to the output terminal of the operational amplifier 212_1.

The positive diode 212_2 may be connected between the output terminal and the inverting input terminal of the operational amplifier 212_1. An anode of the positive diode 212_2 may be connected to the output terminal of the operational amplifier 212_1, and a cathode of the positive diode 212_2 may be connected to the inverting input terminal of the operational amplifier 212_1.

The positive diode 212_2 may rectify and output the control pilot signal CP buffered in the operational amplifier 212_1 and output. For example, the positive diode 212_2 may be provided to prevent the operational amplifier 212_1 from outputting a negative voltage when the voltage level of the control pilot signal CP is lowered from 12 V to 0 V.

The RC circuit 212_3 may include a resistor R having a resistance and a capacitor C having a capacitance.

The RC circuit 212_3 may adjust the voltage level of the control pilot signal CP to a preset voltage level or higher according to a time constant determined by the resistance of the resistor R and the capacitance of the capacitor C, and output the signal as a chip enable signal EN.

A formula for finding the time constant of the RC circuit 212_3 satisfying a condition for enabling the power supply chip (211 of FIG. 3) is as follows.

$${V}_{o} {e}^{- \frac{t}{{R}_{1} {C}_{1}}} \geq {V}_{en} \qquad Formula$$

“V₀” denotes a maximum output voltage of the control pilot signal CP within one period of the control pilot signal CP.

“R₁” and “Cl” denote the resistance of the resistor R and the capacitance of the capacitor C, respectively.

“t” denotes an elapsed time in a section in which the voltage level of the control pilot signal CP is −12 V when the control pilot signal CP is in the third state (State B2 of FIG. 2).

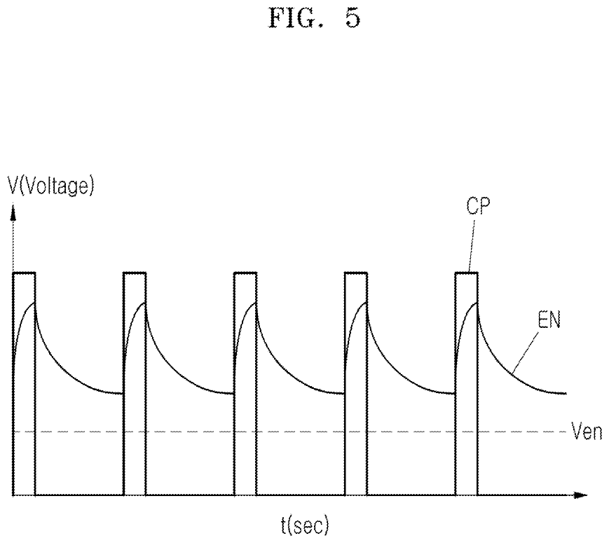

FIG. 5 is a waveform diagram for describing an operation in which the chip enable circuit 212 illustrated in FIG. 4 adjusts the voltage level of the chip enable signal EN based on the voltage level of the control pilot signal CP.

A state of the control pilot signal CP illustrated in FIG. 5 is the third state (State B2 of FIG. 2). When the control pilot signal CP is in the third state (State B2), the control pilot signal CP is transmitted from the EVSE (100 of FIG. 1) to the vehicle (200 of FIG. 1) using a pulse width modulation method. “Ven” denotes a preset voltage level for enabling the power supply chip (211 of FIG. 3).

The chip enable circuit 212 may charge and discharge the capacitor C according to a time constant determined by the resistance of the resistor R and the capacitance of the capacitor C based on the voltage level of the control pilot signal CP to adjust the voltage level to a preset voltage level Ven or higher.

Accordingly, the chip enable circuit 212 may stably enable the power supply chip 211.

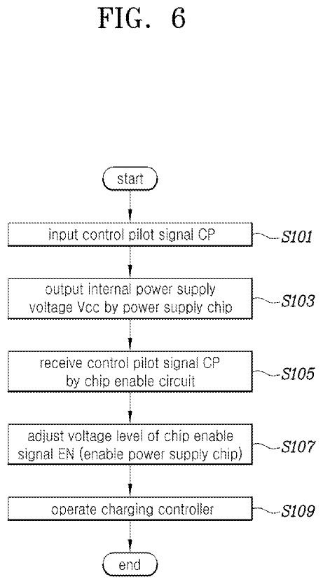

FIG. 6 is a flowchart illustrating a control method of the vehicle battery charging apparatus 210 illustrated in FIG. 3.

In step S101, the power supply chip 211 may receive input of the control pilot signal CP having a voltage level corresponding to a state in which the vehicle 200 is connected to the EVSE wo and is not ready to receive power (that is, the third state (State B2)).

In step S103, the power supply chip 211 may output the internal power supply voltage Vcc according to the voltage level of the control pilot signal CP. More specifically, the power supply chip 211 may be temporarily enabled in a section in which the voltage level of the control pilot signal CP is equal to or greater than a preset voltage level to output the internal power supply voltage Vcc.

In step S105, the chip enable circuit 212 may receive the internal power supply voltage Vcc from the power supply chip 211 to receive the control pilot signal CP.

In step S107, the chip enable circuit 212 may adjust the voltage level of the chip enable signal EN for enabling the power supply chip 211 based on the voltage level of the control pilot signal CP to a preset voltage level or higher. Accordingly, the power supply chip 211 may be stably enabled. That is, even when the state of the control pilot signal CP directly transitions from the first state (State A) to the third state (State B2), the chip enable circuit 212 may adjust the voltage level of the chip enable signal EN to a preset voltage level or higher, thereby stably enabling the power supply chip 211.

In step S109, the charging controller 213 may be operated based on the internal power supply voltage Vcc continuously supplied from the power supply chip 211 to stably charge the vehicle battery. As described above, the vehicle battery charging apparatus according to an embodiment of the present disclosure may stably supply power of the vehicle battery charging apparatus, reduce the cost and area consumed by the vehicle battery charging apparatus, and alleviate discharge of the auxiliary battery.

According to embodiments of the present disclosure, the vehicle battery may be more safely and more effectively charged by stably supplying power of the vehicle battery charging apparatus based on the control pilot signal regardless of a different control pilot communication sequence according to the type of EVSE.

In addition, according to embodiments of the present disclosure, it is possible to reduce the cost and area consumed by the vehicle battery charging apparatus and alleviate discharge of the auxiliary battery by maintaining the enabled state of the power supply chip using the internal power supplied from the power supply chip inside the vehicle battery charging apparatus instead of the power of the auxiliary battery.

In addition, according to embodiments of the present disclosure, it is possible to stably supply power of the vehicle battery charging apparatus based on the control pilot signal without affecting the frequency and the duty ratio of the control pilot signal.

The effects obtainable in embodiments of the present disclosure are not limited to the above-mentioned effects, and other effects not mentioned may be clearly understood by those of ordinary skill in the art to which the present disclosure belongs from the above description.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A vehicle battery charging apparatus comprising:
a power supply chip enabled according to voltage levels of a control pilot signal and a chip enable signal to supply an internal power supply voltage;
a charging controller configured to receive the internal power supply voltage and control charging of a vehicle battery based on the control pilot signal; and
a chip enable circuit configured to receive the internal power supply voltage, receive the control pilot signal, and adjust a voltage level of the chip enable signal based on a voltage level of the control pilot signal to enable the power supply chip.

2. The vehicle battery charging apparatus according to claim 1, wherein the control pilot signal is changeable to any one of a plurality of preset states according to a battery charging sequence between electric vehicle supply equipment (EVSE) and a vehicle.

3. The vehicle battery charging apparatus according to claim 2, wherein:
the power supply chip is enabled when a voltage level of the control pilot signal is a preset voltage level or higher; and
the preset voltage level is set between a maximum voltage level and a minimum voltage level of the control pilot signal corresponding to a state in which the vehicle is connected to the EVSE and is not ready to receive power among the plurality of preset states.

4. The vehicle battery charging apparatus according to claim 3, wherein the chip enable circuit is configured to adjust a voltage level of the chip enable signal to the preset voltage level or higher.

5. The vehicle battery charging apparatus according to claim 4, wherein the power supply chip is enabled when the voltage level of the chip enable signal is the preset voltage level or higher.

6. The vehicle battery charging apparatus according to claim 2, wherein:
the chip enable circuit comprises an RC circuit including a resistor having a resistance and a capacitor having a capacitance; and
the RC circuit is configured to adjust a voltage level of the chip enable signal to a preset voltage level or higher by charging/discharging the capacitor according to a time constant determined by the resistance and the capacitance at a voltage level of the control pilot signal corresponding to a state in which the vehicle is connected to the EVSE and is not ready to receive power among the plurality of preset states.

7. The vehicle battery charging apparatus according to claim 6, wherein the chip enable circuit further comprises:
an operational amplifier configured to receive the control pilot signal through a non-inverting input terminal based on the internal power supply voltage, buffer the control pilot signal, and output the control pilot signal to the RC circuit; and
a positive diode connected between an output terminal and an inverting input terminal of the operational amplifier.

8. The vehicle battery charging apparatus according to claim 1, wherein a duty ratio of the control pilot signal is variable according to current limiting capacity information of electric vehicle supply equipment (EVSE).

9. The vehicle battery charging apparatus according to claim 1, wherein the charging controller is configured to control charging of the vehicle battery by detecting a voltage level, a frequency, and a duty ratio of the control pilot signal.

10. The vehicle battery charging apparatus according to claim 1, wherein an enabled section of the power supply chip is variable according to a duty ratio of the control pilot signal.

11. The vehicle battery charging apparatus according to claim 1, wherein the charging controller is configured to receive the internal power supply voltage to activate a power latch signal and continuously enable the power supply chip based on the activated power latch signal.

12. A method for controlling a vehicle battery charging apparatus, the method comprising:
receiving an input of a control pilot signal;
outputting, by a power supply chip, an internal power supply voltage according to a voltage level of the control pilot signal;
receiving, by a chip enable circuit, the internal power supply voltage to receive the control pilot signal; and
enabling, by the chip enable circuit, the power supply chip by adjusting a voltage level of a chip enable signal based on the voltage level of the control pilot signal.

13. The method according to claim 12, wherein receiving the input of the control pilot signal comprises receiving an input of the control pilot signal having a voltage level corresponding to a state in which a vehicle is connected to electric vehicle supply equipment (EVSE) and is not ready to receive power.

14. The method according to claim 12, wherein outputting comprises outputting the internal power supply voltage in a section in which the voltage level of the control pilot signal is a preset voltage level or higher in the power supply chip.

15. The method according to claim 14, wherein enabling comprises enabling the power supply chip by adjusting the voltage level of the chip enable signal to a preset voltage level or higher.

16. The method according to claim 12, wherein the chip enable circuit comprises an RC circuit including a resistor having a resistance and a capacitor having a capacitance, and wherein the method further comprises adjusting, by the RC circuit, the voltage level of the chip enable signal to a preset voltage level or higher by charging/discharging the capacitor according to a time constant determined by the resistance and the capacitance at a voltage level of the control pilot signal corresponding to a state in which a vehicle is connected to electric vehicle supply equipment (EVSE) and is not ready to receive power.

17. The method according to claim 16, wherein the chip enable circuit further comprises:
an operational amplifier receiving the control pilot signal through a non-inverting input terminal based on the internal power supply voltage, buffering the control pilot signal, and outputting the control pilot signal to the RC circuit; and
a positive diode connected between an output terminal and an inverting input terminal of the operational amplifier.

18. The method according to claim 12, wherein a duty ratio of the control pilot signal is variable according to current limiting capacity information of electric vehicle supply equipment (EVSE).

19. The method according to claim 12, further comprising controlling charging of the vehicle battery by detecting a voltage level, a frequency, and a duty ratio of the control pilot signal.

20. The method according to claim 12, further comprising:
receiving the internal power supply voltage to activate a power latch signal; and
continuously enabling the power supply chip based on the activated power latch signal.
